(19) United States
(12) Patent Application Publication
(10) Pub. No.: US 2006/0197338 A1
(43) Pub. Date: Sep. 7, 2006

(54) Electro-fusion joining system for thermoplastic piping systems

(76) Inventors: Christopher G. Ziu, Lenexa, KS (US); Bradley K. Weisbond, Overland Park, KS (US)

Correspondence Address: FISH & RICHARDSON PC, P.O. BOX 1022, MINNEAPOLIS, MN, 55440-1022, US

(21) Appl. No.: 11/134,879

(22) Filed: May 23, 2005

Related U.S. Application Data
(63) Continuation-in-part of application No. 11/073,436, filed on Mar. 7, 2005.

(51) Int. Cl. F16L 47/02

(52) U.S. Cl. 285/21.1; 285/21.2

(57) ABSTRACT

An electro-fusion drainage system coupling has a tubular body with outer and inner substantially parallel surfaces. The inner surface defines a passageway from end to end. A resistive heating element is disposed in the passageway. In one implementation, a ridge integrally molded on the exterior surface of the body central portion has a first edge generally perpendicular to the coupling outer surface at a predetermined distance from the end. The predetermined distance represents a desired insertion distance of the pipe into the coupling body passageway. The electro-fusion coupling may further include a stop positioned in the passageway to contact the end of the thermoplastic pipe inserted into the passageway. Other implementations include an electro-fusion coupling with a fitting integrally formed on a second end. Other implementations may include a U-shaped member integrally molded on the exterior surface of the body central portion with an exterior stop in the bottom of the U-shaped projection. Methods of use of the invention are also described.

This application is a continuation-in-part of application Ser. No. 11/073,436, filed Mar. 7, 2005, the disclosure of which is incorporated by reference herein.

### TECHNICAL FIELD

This invention relates to electro-fusion couplings and fittings for thermoplastic piping.

### BACKGROUND

Thermoplastic piping has been used to convey corrosive waste discharge from research laboratories since the late 1960s. Prior to that time, borosilicate glass piping was the standard material of choice for the aboveground portions of the piping systems located within buildings. For the underground portions of the systems, high-silicon alloy iron (Duriron) was the material of choice.

In the early 1960s, attempts were made to replace glass and Duriron with low temperature, inexpensive thermoplastics such as polyvinyl chloride (PVC) and acrylonitrile-butadiene-styrene copolymer (ABS), as well as polyethylene. However, PVC and ABS both proved to lack the necessary chemical resistance to common laboratory solvents and environmental stress crack resistance to common disinfectant ingredients such as non-ionic surfactants. Further, PVC, ABS and polyethylene alike all proved to lack the necessary stiffness at elevated temperatures. Since mixtures of laboratory wastes causing exothermic chemical reactions and building temperature changes during construction can both result in thermal expansion, piping materials which soften at high temperatures are more likely to sag and twist between supports, resulting in the development of sagging and back-pitch (back-pitch refers to a situation where the pipes that are supposed to be “pitched” at a constant slope downward, instead bow upwards in places thereby preventing gravity from causing the fluid to flow freely). In drainage systems, back-pitch is highly undesirable as this can result in improper drainage and the possibility of fluid back-up through the system.

Thus, it was determined early on that one material having an ideal mix of chemical resistance to a wide range of acids, bases and organic and inorganic solvents, and a higher glass transition temperature than PVC, ABS, and PE was polypropylene (PP). Upon its introduction in the late 1960s, polypropylene quickly grew to become the standard in the industry. One limitation of polypropylene, however, is that due to its resistance to solvents, joining by solvent cementing is not a ready possibility. The material is instead joined either by some form of heat fusion, or by mechanical connection. Most forms of heat fusion that existed up to that point were limited to heat element socket fusion or heat element butt fusion, both of which have always been considered cumbersome, especially in fitting-intensive piping arrangements such as laboratory waste piping. To address this problem, and to facilitate easier installation of polypropylene into laboratory facilities, a new joining process referred to as “electro-fusion” was developed, e.g., as described in Blumencranz, U.S. Pat. Nos. 3,378,672; 3,465,126; and 3,506,519. This process, involving a wire coil imbedded within the plastic at joint locations, and through which electricity is later passed to create heat and fusion (with pressure applied via external clamping) was developed to make it easier to install polypropylene.

In addition to electro-fusion, once polypropylene corrosive waste systems proved to be a commercial success, mechanical methods of connection were also established as an alternative method to join pipes. Mechanical methods, which involved fittings and couplings of a completely different design from that of the electro-fusion variety soon gained popularity in aboveground installations, particularly in the under-sink plumbing.

After the historic MGM Hotel fire in Las Vegas twenty-five years ago, new building standards were enacted to require that building materials for air handling areas and areas classified as return air plenums satisfy certain flame and smoke density requirements (namely flame spread value of less than 25 and smoke density rating of less than 50 according to ASTM E-84). Polypropylene, while being excellent chemically, unfortunately burns readily and produces relatively dense smoke, and as such is typically unable to meet these required values. Therefore, for a period of time, in those areas classified as fire rated, users were forced to transition to borosilicate glass or duriron through some means of mechanical connection. However, in the early 1990s, a special formulation of polyvinylidene fluoride (PVDF), a fluoropolymer thermoplastic material known for its fire resistance as well as its excellent chemical resistance, was able to pass the required flame spread and smoke density requirements (when tested to ASTM E-84) of most building codes. As a result, PVDF has since become the standard corrosive waste material of choice in those portions of buildings designated as fire rated areas. PVDF, like polypropylene, is highly solvent resistant, and able to be joined by the same methods inherently used on PP (e.g. electro-fusion and other heat fusion methods, and mechanical joining methods).

While the electro-fusion method has appeal, it has not been without its problems as there are many subtleties that can result in problems in joining polypropylene and PVDF by electro-fusion. Additionally, subtleties in joint design, coupled with inadequate joining, can lead to failures occurring in service after prolonged periods of time. For this reason, many projects have suffered through severe installation difficulties, while others have seen after installation failures occur due to chemical attack mechanisms.

Generally, contractors tend to prefer the labor savings and ease of joining offered by mechanical joining methods, whereas engineers and code officials tend to prefer the use of fused joints in areas that are inaccessible, such as behind walls and in underground locations. Most engineers tend to view fused joints as having less likelihood of leaks over time. Conversely, most engineers and code officials tend to view mechanical methods as having a distinct possibility of loosening over time, whereby leaks could occur. As a result, most mechanical joints are limited to installations where there is access to repair the joints, if needed.

In prior art electro-fusion methods developed for corrosive waste systems, the methods involve putting a minimum amount of heat into the joints, and using a coupling design with a small mass of material. In order to create pressure between the coupling or fitting coupling portion and the pipe to be fused, external clamps are required during the electro-fusion process. The clamping force required is difficult to quantify. If the contractor does not apply a sufficient clamping force, or too much clamping force is applied, a poor joint can result. Since there are many human elements involved in the joining processes, and a minimum amount of heat is introduced into the joints, the results are often less than satisfactory. In the best-case scenario, when all steps of the fusion process are performed properly, the joints are typically rated for drainage pressures only. However, if one or more of the steps involved are not followed properly, or tolerances are less than ideal, the result may be a high rate of leaks encountered during the joining process. In any event, the requirement for clamping adds a significant amount of additional labor on sizeable projects.

In prior art electro-fusion systems as shown in U.S. Pat. Nos. 6,450,544 and 6,250,686, a single coupling incorporates changeable sleeves to allow for joining by either electro-fusion or mechanical means using the same coupling. However, while providing some advantages in reducing the number of parts needed for manufacture and inventory, the prior art systems do not solve some of the fundamental problems described in the previous paragraphs. One of the problems with the prior art systems is the need to use manually-applied external clamping force during the electro-fusion cycle (accomplished by hand tightening of a nut). Additionally, in the prior art, when joining by either electro fusion or mechanical method, a short piece (“pup”) of pipe is required when making the fitting-to-fitting connections. Since the mechanical coupling utilizes an external threaded nut, this can loosen over time due to expansion and contraction, leading to failure later in service.

Additionally, with prior art electro-fusion couplings, an installer has no way to apply additional clamping force, in the event a second or third fusion cycle is required, e.g., because the first cycle did not create a pressure-tight joint and the threads of the prior art coupling may have become fused tight in the first fusion cycle. This problem occurs in many installations because the prior art joint uses a minimum amount of heat, and depends on manual force for applying pressure during the joining process.

Another disadvantage in prior art electro-fusion systems used in corrosive waste systems, as well as in many prior art mechanical joint systems, is that a fitting-to-fitting joint requires that a short pipe nipple be cut and prepared, resulting in additional labor and two distinct joints.

Mechanical joints are satisfactory for installation in certain accessible areas, and electro-fusion is satisfactory underground and behind walls, but in applications involving both methods, the requirement for different fitting types is a disadvantage.

### SUMMARY

The present disclosure pertains to electro-fusion couplings and fittings for use with a thermoplastic piping system adapted for use in corrosive waste piping systems. The piping system incorporates use of plain end fittings with use of electro-fusion couplings and fittings. Plain end pipe and plain end fittings are capable of use with other prior art joining systems such as heat element butt fusion, heat element socket fusion, mechanical joint, solvent cementing or adhesive bonding. Therefore, the electro-fusion system of the present invention can be used individually on a given installation, or several of the listed methods can be combined on a given project, e.g., with different methods used in different portions of the system. Regardless of the method or methods used on a given installation, common fittings can be used interchangeably since the end configuration is always the same.

In the electro-fusion method, the piping system makes use of full integrity “pressure rated” electro-fusion technology using molded-in wire or post-molding imbedded wire and “clampless” designs for the coupling. The resulting installation in a gravity drainage system is pressure-testable and pressure rated to at least the rating of the component having the lowest pressure rating installed in the system. This is highly desirable for applications involving critical fluids that are to be drained down the systems by gravity, due to the unprecedented level of afforded safety factor. The electro-fusion system of the present disclosure results in a relatively much higher level of fusion integrity, and one that is more repeatable for polypropylene, PVDF and other thermoplastic piping systems.

As discussed above, advantages of the present system include full pressure integrity without exterior clamping of the joint during fusion. The coupling wall thickness of the present invention is predetermined to be sufficient to restrain the coupling from expanding during the heat fusion stage of coupling. The thickness of the coupling is equal to or greater than the wall thickness of the associated pipe, thereby providing a pressure rating equal to or greater than the pipe. Further advantages include use in a system of plain end fittings, thereby eliminating the need for short pipe nipples. Other advantages of the electro-fusion coupling of the present disclosure include the reduced space required for assembly of an electro-fusion coupling compared to a mechanical coupling. For example, a mechanical coupling requires additional space for manipulating a wrench to tighten the mechanical fasteners (bolt and nut) of the mechanical clamp rather than slipping the electro-fusion coupling on and connecting the power supply wires to the coupling terminals.

In one embodiment, an electro-fusion drainage system coupling has a tubular body defining an outer surface and an inner surface, the outer surface and the inner surface being substantially parallel, the inner surface defining a passageway from a first end to a second end. A first resistive heating element is disposed in the passageway. The resistive heating element may be disposed in the passageway, e.g., in a spiral groove cut in the interior surface of the body of the coupling with a resistive heating element wire laid down in the groove, or the groove may be a continuous spiral from a first end portion of the coupling to a second end portion. Alternatively, a first spiral groove may be inscribed in the surface of the first end portion to the central portion of the coupling and a second spiral may be inscribed from the central portion to the second end portion of the body, with a first resistive wire disposed in the first spiral groove and a second wire disposed in the second groove. The wires may be electrically connected. In yet another implementation, a tubular preformed sleeve has a resistive heating element comprising a spiral wound wire disposed on an outer surface of the sleeve. A tubular body is over-molded over the sleeve and heating element.

The electro-fusion coupling may include a first radial opening from the inner surface to the outer surface of the body and a second radial opening from the inner surface to the outer surface of the first portion of the body. A first conductive terminal is disposed in the first radial opening and electrically connected to the resistive heating element and a second conductive terminal is disposed in the second radial opening and electrically connected to the resistive heating element.

The resistive heating element of the electro-fusion coupling may be coated with fluoropolymer or other polymer coating such as polyamide-imide before being disposed in the groove of the coupling body or coated with fluoropolymer after being disposed in the groove of the coupling body.

In some embodiments, at least one ridge is integrally molded on the exterior surface at the central portion of the body. The ridge has a first edge generally perpendicular to the outer surface of the coupling positioned at a predetermined distance from the end of the body. The predetermined distance is representative of a desired insertion distance of a first proximal end portion of first thermoplastic pipe inserted into the passageway of the coupling body.

In some implementations, the electro-fusion coupling further includes a stop in the passageway of the body, the stop being positioned for contact with a first proximal end portion of first thermoplastic pipe inserted into the passageway of the coupling body. The stop may comprise a continuous circumferential ring of the same material as the body of the coupling and the ring is sized to be partially received in a radial groove milled in the inner surface of the body. The groove is milled in the inner surface before the resistive heating element is put in place.

The electro-fusion coupling may include a pop-up fusion indicator having an annular depression on an outer surface of a portion of the fitting body. The annular depression extends into but not through the sidewall. An integral button of sidewall material is disposed to the center of the annular depression.

The electro-fusion coupling may further comprise a fitting integrally formed on a second end of the coupling. The fitting may be a tee-fitting, elbow-fitting, wye-fitting, or other standard waste discharge system fitting.

In another implementation, the electro-fusion coupling has at least one U-shaped member integrally molded on the outer surface of the central portion. The U-shaped member has a first leg and a second leg adapted to contact a first proximal end portion of a first thermo-plastic pipe to be inserted into the passageway of the coupling body. An outer stop is disposed in the bottom of the U-shaped member. The stop has a first edge generally perpendicular to the bottom of the U-shaped member and positioned at a predetermined distance from the end of the body. The predetermined distance represents a desired insertion distance of a first proximal end portion of first thermoplastic pipe into the passageway of the coupling body.

In some implementations, the thermoplastic piping system may be in the form of a kit having at least one mechanical coupling with a predetermined interior diameter and predetermined length configured to accept and couple a thermoplastic pipe of a specified outside diameter. The kit further includes at least one electro-fusion coupling having a predetermined interior diameter configured to accept and couple a thermoplastic pipe of the specified outside diameter of the pipe to be coupled by the mechanical coupling. The electro-fusion coupling has a longitudinal length substantially equivalent to the length of the mechanical coupling. The electro-fusion coupling has an internal working pressure equal to or greater than internal working pressure of the mechanical coupling.

Polymeric waste discharge system pipe may be joined using the electro-fusion coupling of the present disclosure by the steps of: providing a first piece and a second piece of polymeric tubular pipe to be joined, each with a proximal terminal end and a proximal end portion adjacent to the proximal terminal end; and providing an electro-fusion coupling (or fitting with electro-fusion ends); inserting the proximal terminal end of the first piece of pipe to be joined in a first end portion of the electro-fusion coupling for a predetermined distance of insertion; inserting the proximal terminal end of the second piece of pipe to be joined in a second end portion of the electro-fusion coupling for a predetermined distance; and applying an electrical current to the resistive element to heat the resistive heating element to a temperature sufficient to fuse each end of the tubular pipe to the coupling absent any external support applied to the outside of the tubular body of the electro-fusion coupling. In certain implementations, the method of joining may further include steps of: positioning a squared-off, terminal proximal end of the pipe to be joined adjacent to and in contact with an integral ridge molded on the exterior parallel surface of the central portion of the electro-fusion coupling, wherein the tubular pipe is further positioned such that a longitudinal axis of the pipe and a longitudinal axis of the coupling are generally parallel to each other and an outside surface of tubular pipe is adjacent to and in contact with the outside parallel surface of the electro-fusion coupling; marking the outside surface of the pipe at the end of the coupling, wherein the distance from the mark on the outside of the pipe to the terminal end is the predetermined distance of insertion of the first proximal terminal end of the pipe into the first end portion of the electro-fusion coupling. The method may also include the step of inserting the terminal proximal end of the pipe to be joined into the electro-fusion coupling until the terminal end contacts a stop disposed on the interior surface of the central portion of the coupling.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an electro-fusion coupling with a resistive heating element in an internal passageway;

FIG. 2 is an end view of the electro-fusion coupling of FIG. 1;

FIG. 3A is a cross-sectional side view of the electro-fusion coupling taken along section 3A-3A of FIG. 2;

FIG. 3B is a cross-sectional side view of an electro-fusion coupling taken along section 3B-3B of FIG. 2 with a resistive heating element configured differently than that of the implementation of FIG. 3A;

FIG. 3C is an enlarged partial cross-section of a portion of FIGS. 3A and 3B illustrating a pop-up fusion indicator and an electrical terminal connector;

FIG. 3D is an enlarged partial cross-section taken along section 3D-3D of FIGS. 3A and 3B illustrating a pop-up fusion indicator and an electrical terminal connector;

FIG. 4 is a partial cross-sectional side view of a polymeric pipe to polymeric pipe connection, using the electro-fusion coupling of FIG. 1:

FIG. 5 is a partial cross-sectional side view of a polymeric pipe to polymeric pipe connection, using a prior art mechanical coupling;

FIG. 6 is a cross-sectional side view of a polymeric pipe to polymeric elbow connection joint, using the electro-fusion coupling of FIG. 1 and a prior art plain end elbow;

FIG. 7 is a partial cross-sectional side view of a polymeric pipe to polymeric elbow connection joint, using a prior art mechanical coupling and a prior art plain end elbow;

FIG. 8 is a cross-sectional view of elbow fitting with an integrally-formed electro-fusion coupling on at least one end of the elbow joined to a polymeric pipe;

FIG. 9 is a partial cross-sectional side view of the electro-fusion coupling of FIG. 4 with a portion of a polymeric pipe to be joined shown positioned with a terminal end in contact with an exterior ridge of the coupling;

FIG. 10A is a perspective view of an electro-fusion coupling with a U-shaped projection for holding an end of a pipe to be coupled while marking a predetermined depth of insertion on an end portion of the pipe to be coupled;

FIG. 10B is a perspective view of another implementation of an electro-fusion coupling with a U-shaped projection for holding an end of a pipe to be coupled while marking a predetermined depth of insertion on an end portion of the pipe to be coupled;

FIG. 10C is a perspective view of another implementation of an electro-fusion coupling with a U-shaped projection for holding an end of a pipe to be coupled while marking a predetermined depth of insertion on an end portion of the pipe to be coupled;

FIG. 11A is an end view of the electro-fusion coupling of FIG. 10A;

FIG. 11B is an end view of the electro-fusion coupling of FIG. 10B;

FIG. 11C is an end view of the electro-fusion coupling of FIG. 10C;

FIG. 12 is a partial cross-sectional side view of the electro-fusion coupling of FIGS. 10A, 10B or 10C with a portion of polymeric pipe to be joined shown positioned with a terminal end of the pipe in contact with a stop in the bottom of the U-shaped projection of the coupling;

FIG. 13 is an end view of another implementation of the electro-fusion coupling having U-shaped projections for measurement spaced circumferentially around the outer surface of the coupling;

FIG. 14 is a cross-sectional view of an electro-fusion coupling having a wall thickness that decreases with distance from the center of the coupling to the ends of the coupling;

FIG. 15 is an end view of the electro-fusion coupling of FIG. 14;

FIG. 16 is a cross-sectional view of an electro-fusion coupling having a wall thickness that decreases with distance from the center of the coupling to the ends of the coupling and includes U-shaped projections for measurement;

FIG. 17 is an end view of the electro-fusion coupling of FIG. 16;

FIG. 18 is a perspective view of an electro-fusion coupling with a stiffening ring of higher tensile strength material disposed on the electro-fusion coupling of FIG. 1;

FIG. 19 is an end view of the electro-fusion coupling of FIG. 18;

FIG. 20 is a cross-sectional view of a transition coupling having a bell connection for use with a fusion sealing system and a spigot end for use in a prior art mechanical or socket system; and

FIG. 21 is an end view of an alternative implementation of an electrofusion coupling wherein the legs of the U-shaped projection are disposed tangent instead of radially.

Like reference symbols in the various drawings indicate like elements.

### DETAILED DESCRIPTION

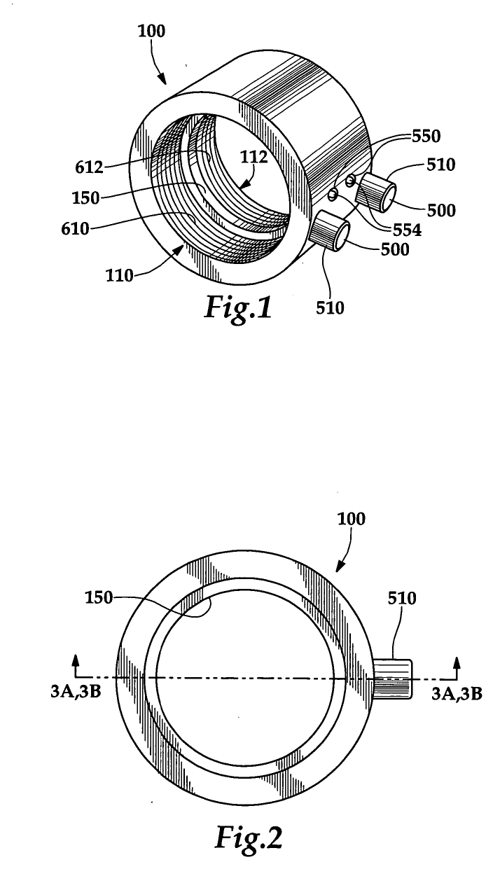

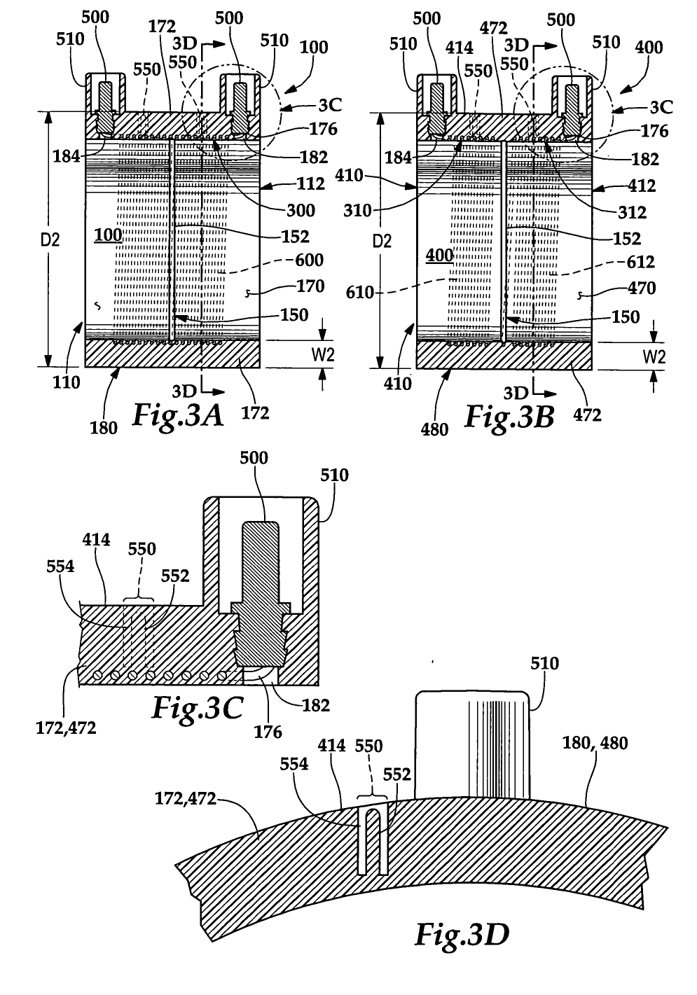

Referring now to FIGS. 1, 2, 3A and 4, an electro-fusion coupling 100 for making electro-fusion (re: ASTM F 1073 and ASTM F 1290) connections between carrier pipe and/or other fittings (hereinafter referred to generally as “couplings”) of various configurations is designed to receive pipes 210 and 212 in opposing socket ends 110 and 112. On the interior of the coupling 170, there is a wire circuit 300. The circuit 300 can consist of one circuit that runs from a near first end 110 of the coupling 100 to a second end 112. Alternatively, the coupling 100 can contain two separate wire circuits, one for each of the opposing socket ends 110, 112, (FIG. 3B). On the interior of the coupling, there may be an optional center stop 150. In this particular implementation, stop 150 is a full circumferential stop formed of the same material as the coupling body. This is desirable in drainage systems so a smooth interior surface is in the flow area of a gravity draining system. The stop 150 can be configured so that in cross-section, it is essentially “square” to match pipe and fitting ends that are squarely cut. Alternatively, the stop can be implemented with a smooth bevel (i.e. radius), e.g., having a radius of 3 mm or ⅛-inch, with all ends of pipes and fittings advantageously prepared with the same external bevel to match the contour of the bevel so that when the pipe or fitting ends are properly inserted, the ends are essentially flush with the stop resulting in a substantially smooth surface to be encountered by the fluid flow of the draining system.

Several methods of manufacture will be discussed later in this specification. For couplings manufactured by a wire inlaying method, the interior pipe stop can be manufactured using a separate continuous polypropylene ring, which is later assembled into a counterbore 152 on the inside surface 170 of the coupling. This method allows for a full circumferential stop to be used on the inside diameter of the coupling, which is otherwise difficult to achieve with a coupling where the wire is inlaid by this method. A full circumferential stop, or nearly full circumferential stop, is desirable in gravity-flow drainage applications to prevent fluid flow from slowing down, and creating the possibility of fluid back-up.

Referring now to FIG. 9, in implementations where there is an interior stop 150, it is helpful to the contractor to mold a corresponding exterior ridge 160 of the same thickness and in the same exact center position. The contractor can then mark (M) the exterior of a pipe to 212 for the proper depth of insertion, L₂, of pipe to make certain the pipes are fully inserted into the coupling so as to produce a smooth bore across the pipe-to-pipe interface when the joint is made. The length from the terminal edge of the coupling 100 to the perpendicular edge 162 of the ridge 160 is L₁. The distance L₁ is equal to L₂. This external ridge can also function as a stiffening ring, thereby reducing the thickness to which the coupling must be molded to achieve a full rating for the coupling joint as closely equal as possible to the thickest associated pipe to be joined, thereby reducing material costs.

In an embodiment where no interior stop is provided, it may be beneficial to incorporate a ring or rings on the exterior of the coupling to assist the contractor in properly marking pipe. In fact, it is beneficial to have two half rings on opposite ends of the coupling to allow use of either side of the coupling for marking the pipes, without having to flip the coupling around. This construction also adds a significant degree of stiffening.

There are several methods for manufacture of the coupling with the wire imbedded beneath the surface, e.g., by molding-in the wire using a preform (U.S. Pat. No. 4,224,505), or by the wire inlaying process (U.S. Pat. Nos. 6,751,840 and 6,530,139). In one implementation of the present disclosure (FIGS. 3A and 3B), a spiral groove 600 is inscribed on the inner surface 170 of a preformed coupling. It will be understood that the spiral groove may be of a continuous consistent pitch from beginning to end or the pitch of the spiral may change one or more times from the beginning of a groove to the end of the groove. A resistive heating element comprising a wire 176 is disposed in the spiral groove. First and second radial openings 182 and 184 extend from the inner surface 170 to the outer surface 180 of the coupling body. A first conductive terminal 500 is disposed in the first opening and electrically connected to a first end region of the resistive heating element 176 and a second conductive terminal 500 is electrically connected to a second end region of the resistive heating element 176. The terminal connectors 500 can be of any diameter, but it is preferentially one of several standard diameters, including 4.0 mm, 4.7 mm, or other standard pin sizes. Surrounding the terminal connection, the molded coupling body includes a cylindrical terminal protector comprising a protective sleeve 510 formed around the terminal connector 500, so that when the connector is affixed to the heating element leads, it is shielded by the terminal protector, thereby minimizing exposure of an installer to a terminal and reducing chances for injury due to electrocution. Such terminal protectors may be used with other implementations of the electro-fusion couplings of the present invention.

As illustrated in FIGS. 3B and 3C on the exterior of the coupling 100, there can be affixed “pop-up” fusion indicators 550. Pop-up fusion indicators have an annular depression 552 into the surface 180, 480 and penetrating into the tubular body sidewall 172, 472. Integral button 554 of sidewall of material is left in the center of the annular depression 552. In the preferred embodiment, the annular depression 552 is molded integrally into the sidewall 172, 472 leaving the central indicator button 554 in the center of the annular depression. Alternatively, the annular depression 552 may be drilled in the sidewall 172 or 472. Prior art fusion indicators typically consist of a button and spring inserted into a depression in the sidewall of a coupling. The present design represents a significant cost savings over the prior art because the button is formed integral to the body. Additionally, since the button is integral to the body it will not detach from the coupling and become lost prior to the fusion. The indicators are forced to rise by molten fusion material in the wall of the coupling, thereby indicating that fusion has taken place. Pop-up-fusion indicators may be used with other implementations of the electro-fusion coupling of the present invention.

Referring to FIG. 3B, in another implementation, the electro-fusion drainage system coupling 400 is similar to the first implementation. The coupling includes a tubular body having: a first end portion proximal to a first end 410; a second end portion proximal to a second end 412; a central portion 414 between the two end portions; and an outer surface 480 and an inner surface 470. The outer surface 480 and the inner surface 470 are substantially parallel, with the inner surface defining a passageway from the first end 410 to the second end 412. A first spiral groove 610 is inscribed in the inner surface 470 extending from the central portion 414 of the body. The inscribing tool changes the pitch of inscribing in the central portion 414 leaving a space for the stop ring 150 in the central portion and a second spiral groove 612 is inscribed in the inner surface 470 extending from the central portion 414 of the body the second portion 412 of the body. A first resistive heating element comprising a wire 310 is disposed in the first spiral groove 610 and a second resistive heating element 312 comprising a wire is disposed in the second spiral groove 612. The first and second heating elements may be electrically connected. Alternatively, a single wire may be laid down from the first portion 410 across the center portion 414 to the second portion 412. First and second radial openings 182 and 184 extend from the inner surface 470 to the outer surface 480 of the coupling body. A first conductive terminal 500 is disposed in the first opening and electrically connected to the resistive heating element and a second conductive terminal 500 is electrically connected to the resistive heating element. The coupling 400 may also include a stop 150 and fusion indicators 550 as illustrated and discussed in the first implementation disclosed in FIG. 3A.

In an alternative embodiment, the electro-fusion coupling may be manufactured using a prior art socket fusion coupling wherein at least one end of the coupling has the interior milled to predetermined dimension and then a spiral groove is milled on the interior surface as has been described with regard to FIGS. 3A and 3B. A resistive heating element is disposed in the groove and connected to terminals as heretofore described. It will be understood that both ends of the socket fusion fittings may be milled and have a resistive heating element installed or only one end may have the heating element installed whereby the remaining end may still function as a socket coupling.

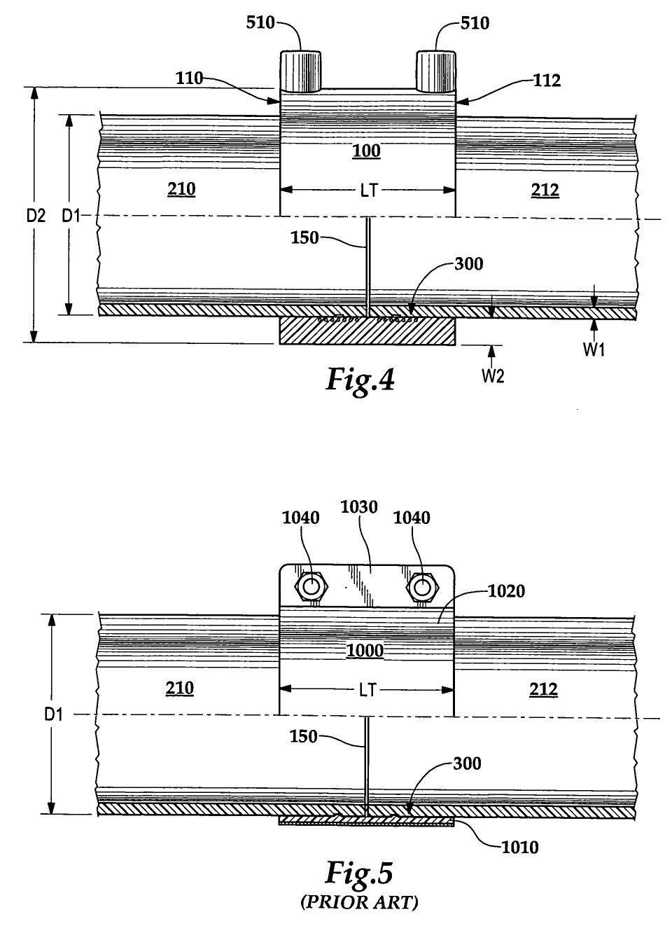

Referring now to FIG. 4, the electro-fusion coupling 100 of the present disclosure joins two pieces of pipe 210 and 212 with outside diameter D₁. The inside diameter of the coupling is substantially equal to the outside diameter D₁ of the pipe to be joined. The outside diameter of the coupling is denoted as D₂. The overall axial length of the coupling 100 is illustrated as L_{T}. Referring in comparison to FIG. 5, a prior art mechanical coupling 1000 (manufactured by the assignee of this application) joins a pipe of outside diameter D₁ having the same overall longitudinal length L_{T}. The prior art mechanical coupling 1000 includes a polymeric sleeve 1010 placed in contact with the end regions of pipes 210 and 212 to be joined and an exterior metal sleeve 1020 with opposed ears 1030 and conventional fasteners 1040. The common longitudinal length L_{T} permits interchangeability of the mechanical and electro-fusion couplings on the same construction site. Applicant believes the longitudinal length L_{T} is shorter than any commercially available electro-fusion coupling of the same pressure rating. Approximate internal diameter, external diameter and total length of one embodiment of the electro-fusion coupling is in the Table 1 below.

TABLE 1

Coupling Nominal Size

| | 3-inch | 4-inch | 6-inch | 8-inch |
|---|---|---|---|---|
| D₁ | 4.315 | 5.450 | 7.70 | 9.7 |
| D₂ | 3.524 | 4.303 | 6.236 | 7.768 |
| L_{T} | 8.500 | 8.500 | 9.500 | 9.500 |

It will be understood that the dimensions in Table 1 are for illustrative purposes only, and not intended to be limiting on the scope of the present invention.

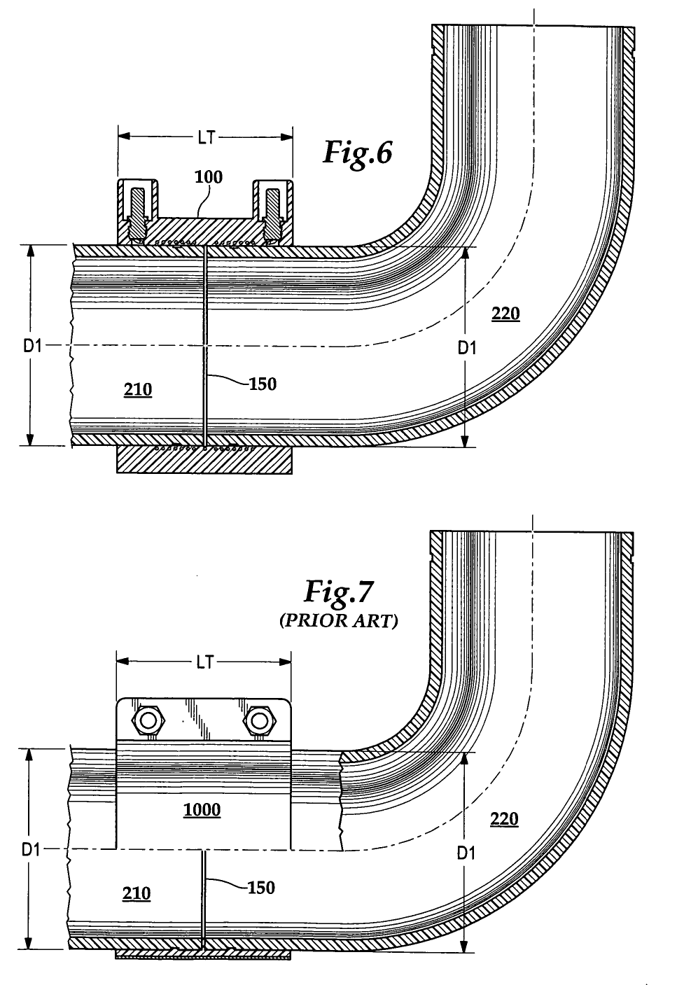

Referring to FIGS. 6 and 7, therein is illustrated a polymeric elbow 220 joining to a polymeric pipe 210 with a polymeric coupling 100 (FIG. 6) and with a standard prior art mechanical coupling 1000 (FIG. 7). Again, the prior art clamp has total longitudinal length L_{T} equal to the longitudinal length L_{T} of the electro-fusion coupling, which permits interchangeability of the mechanical and electro-fusion couplings on the same construction site. Referring again to FIG. 3, the wall thickness W₂ of the coupling 100 is predetermined to be of thickness sufficient to restrain the coupling from expanding during the heat fusion stage of the coupling process. The thickness of the pipe coupling W₂ is equal to or greater than the wall thickness W₁ of the pipe to be joined.

The electro-fusion couplings 100, 400, 700, 800 and 900 are designed with an internal working pressure rating equal to or greater than that of an equivalent mechanical coupling 1000.

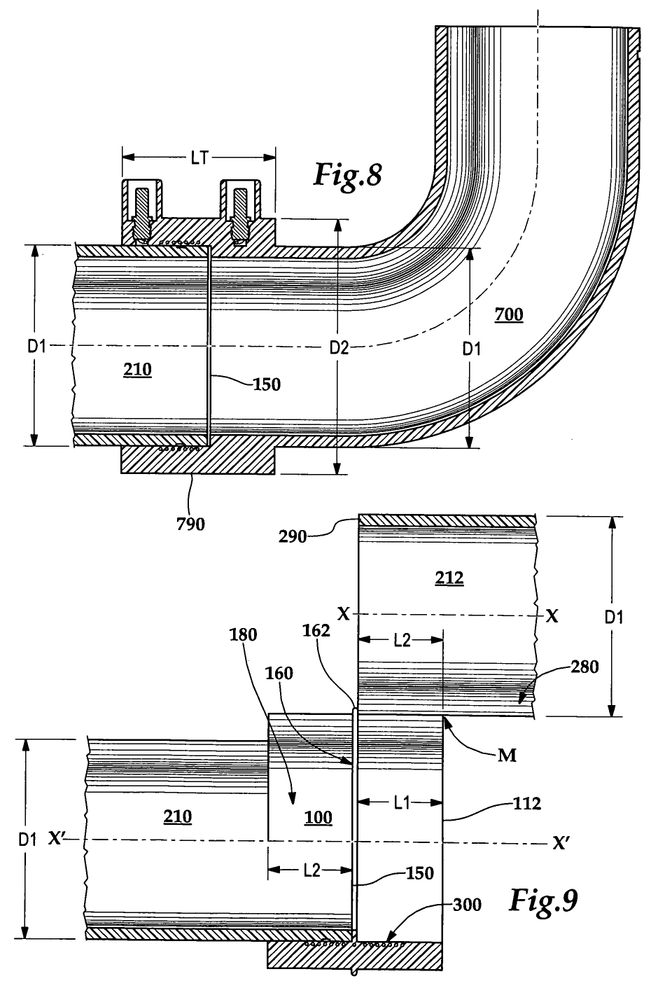

Referring now to FIG. 8, an elbow fitting 700 has an integral coupling 790 formed on one end. The external diameter of the electro-fusion coupling end of the elbow fitting is D2, which is the same outside diameter (D2) of the electro-fusion fitting 100, 400 and 800. The integral coupling may be manufactured as an integral electro-fusion coupling or an integral prior art socket coupling may have the socket milled to predetermined dimensions and the electro-fusion wires laid down in grooves milled into the socket fusion coupling as described with regard to FIGS. 3A and 3B.

Referring now to FIG. 9, therein is illustrated a method of determining a preferred length of insertion of a pipe 210 into the coupling 100. A squared off terminal proximal end 290 of the pipe 212 is positioned adjacent to and in contact with an external ridge 162 molded on the exterior parallel surface 180 of the central portion of the electro-fusion coupling 100. The tubular pipe 212 is further positioned such that a longitudinal axis XX of the pipe 212 and a longitudinal axis X′X′ of the coupling 100 are parallel to each other and an outside surface 280 of tubular pipe 212 is adjacent to and generally in contact with the outside parallel surface 180 of the electro-fusion coupling. The pipe installer or helper marks the outside surface 280 of the pipe 212 where the end of the coupling is contacting the pipe with a mark designated herein by reference numeral M. The distance L₁ from the mark (M) on the outside of the pipe 212 to the first proximal terminal end 290 of the pipe is equal to the predetermined distance L₂ of insertion of the first proximal terminal end 290 of the pipe into the end portion of the electro-fusion coupling 100.

In some implementations, it is desirable to protect the wire resistive heating elements 600, 610, 612 with a tough, high temperature corrosion resistant coating, e.g., fluoropolymers such as PFA (one of the grades of Teflon®) or polyamide-imide (PAI), on the wire. This is especially desirable when using chemically-reactive wire substances such as copper. Copper is beneficial due to its electrical properties in helping to minimize the required voltages for fusion, but it can react readily when in contact with corrosive acids and caustic solutions. Copper, when used with PP systems, may also induce stress cracks in polypropylene. In particular, copper ions, freed during reaction with acids and caustic solutions, can function as a stress-cracking reagent, which, if stress is present in the system, can lead to complete fracturing of the joints. Thus, it is desirable to protect the wire, e.g., by means of a coating, as a conservative measure. It is further beneficial to protect the wire with a coating that also serves a dielectric function so that if wires migrate during the fusion, the dielectric characteristic helps to prevent the wires from burning out or shorting out.

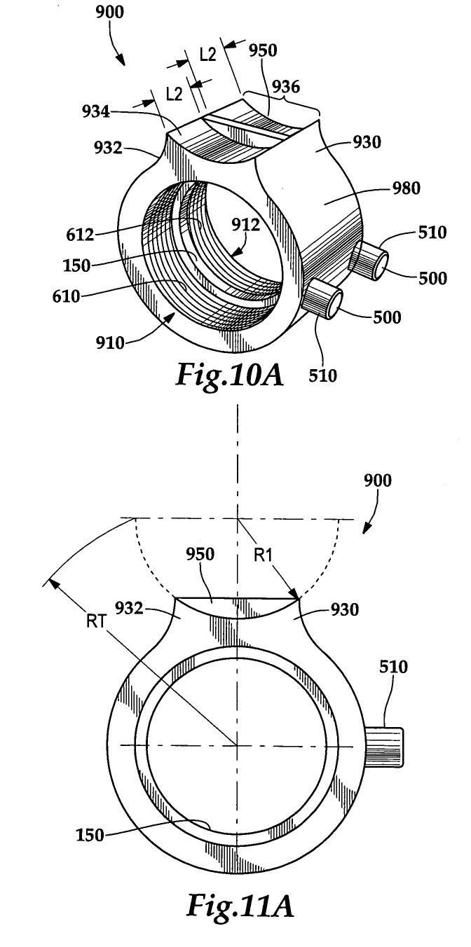

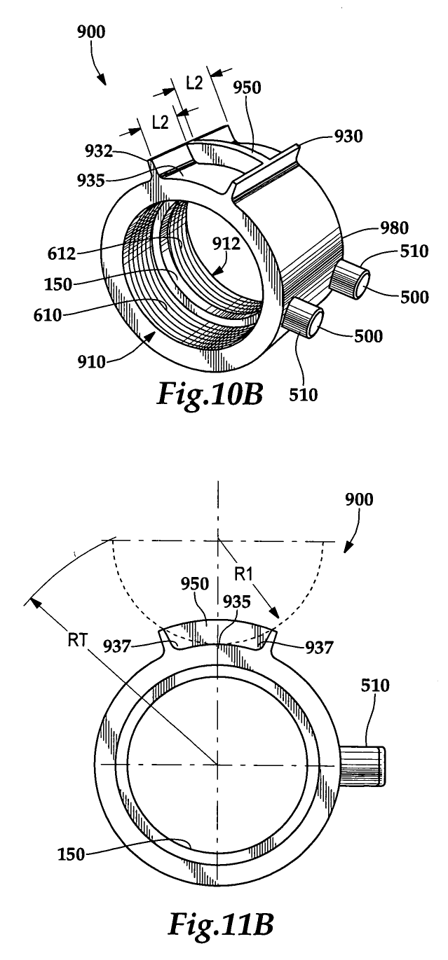

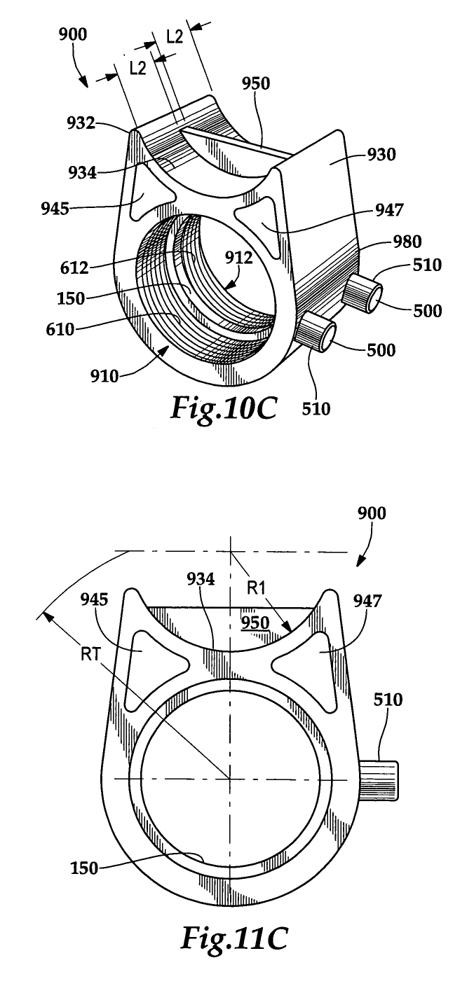

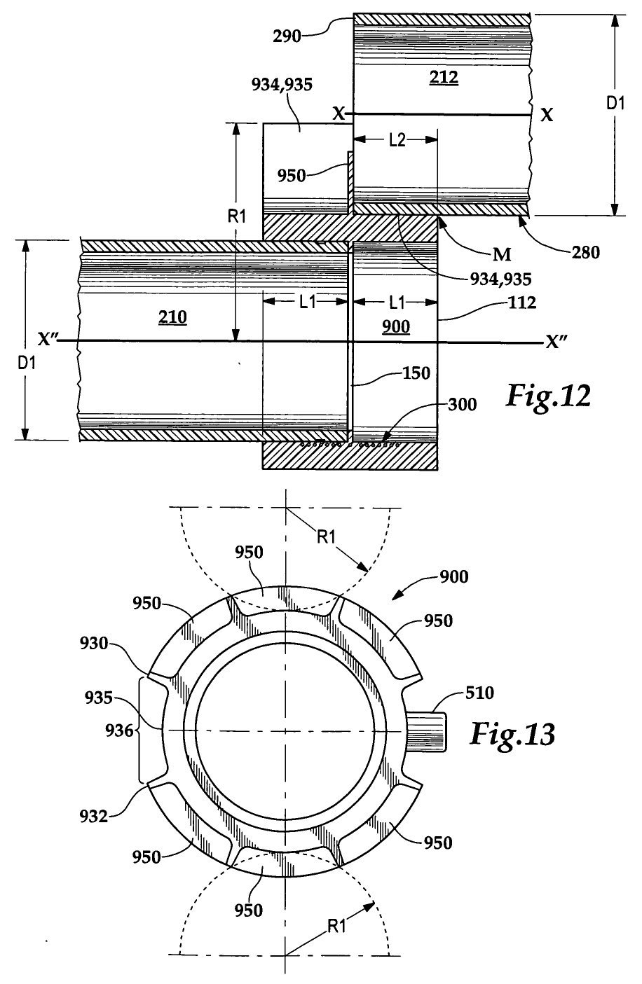

Referring to FIGS. 10A, 10B, 10C, 11A, 11B, 11C and 12, in conjunction with the external ridges 162 (FIG. 9) that assist in marking of the pipes to be joined, it is further beneficial to have the sides of the coupling alternatively having a “U-shaped” profile attached to or molded integrally with the outer surface of the coupling. Referring now in particular to FIGS. 10A and 11A, electro-fusion coupling 900 includes a U-shaped projection 936 having two upwardly disposed sides 930, 932 connected to or formed integrally with the outer surface 980 of the coupling 900. The concave inner surface (bottom) 934 of the U-shaped projection is configured to correspond to the outside diameter D₁ of the pipe to be joined (see FIG. 12), e.g. 2-inch IPS pipe has an outside diameter of 2.375 inches; therefore the radius R₁ of the inner curve of the U-shaped projection should be 1.1875 inches so that when the coupling is held against the corresponding pipe to mark it, it fits snugly and uniformly against the outer pipe wall.

Referring to FIG. 12, the tubular pipe 212 is positioned such that the longitudinal axis of the pipe XX and the longitudinal axis X″X″ of the coupling 900 are parallel to each other and the outside surface 280 of the tubular pipe 212 is adjacent to and generally contacting the inside surface 934, 935. If the U-shaped profile extends all the way to the ends of the coupling, together with the coupling insertion marking stop 950, the contractor can make a smooth semicircular mark “M” around a portion of the exterior of the pipe to be joined (e.g. for approx. 90 degrees) in exactly the right spot to indicate the desired insertion length L₂ of the pipe 212 as was previously discussed in regards to FIG. 9. By rotating the coupling (or the pipe end) in this position several times, the contractor can make a complete circle around the pipe to provide a full and complete mark for proper insertion of the pipe. In this way, the couplings serve as a marking tool to insure proper installation, as well as a coupling.

As a further benefit, the U-shaped projections can function as integral stiffening ribs, which together with the external central stop 950 provide significant stiffening, thereby further lessening the overall mass (and material) required to mold an acceptable coupling.

Referring to FIGS. 11A, 11B and 11C, the outside radius R_{T} of the sides 930 and 932 of the U-shaped projections should be limited to a dimension that allows the coupling to fit within the likely inside diameter of the common corresponding outer pipes within which it is likely to be contained in a dual containment system. This normally means within a pipe of reasonable wall thickness two nominal pipe sizes larger than the corresponding pipe to which the coupling is joined. For example, a 2-inch IPS pipe and coupling is normally housed within a 4-inch IPS pipe, a 3-inch IPS and coupling is housed under a 6-inch IPS pipe, a 4-inch within an 8-inch, a 1-inch within a 3-inch, an 8-inch within a 12-inch, etc.

Referring to FIGS. 10B and 11B therein is another implementation of the electro-fusion coupling of FIGS. 10A and 11A. However, the bottom wall 935 of the U-shaped projection is configured differently to save on material used in constructing the coupling. Sidewalls 930 and 932 are positioned to receive the outside surface of the pipe to be coupled as in FIGS. 10A and 11A. However, the bottom wall 935 follows the surface of coupling 900 and creates voids 937 between the U-shaped member and the outer surface of the pipe to be joined instead of bottom 934 following the radius R₁ as in the implementation of FIG. 10A. The void area is an area not filled by material of the coupling thereby saving on the amount of material used in the coupling.

Referring to FIGS. 10C and 11C therein is another implementation of the electro-fusion coupling of FIGS. 10A and 11A. However, the U-shaped projection is configured differently to save on material used in constructing the coupling. Sidewalls 930 and 932 are positioned to receive the outside surface of the pipe to be coupled as in FIGS. 10A and 11A. The bottom 934 of the U-shaped member follows the radius R₁ as in the implementation of FIG. 10A. However, voids 945 and 947 are molded between the surface of the coupling and the bottom of the U-shaped projection, thereby saving on material.

Referring to FIG. 13 is another implementation of an electrofusion coupling wherein multiple center stops 950 and multiple U-shaped projections 936 are disposed around the outside circumference of the coupling. The center stop 950 functions as a stiffening cross brace and the U-shaped projections 936 serve as stiffening vanes, thereby allowing the coupling wall thickness to be reduced and in a savings of material used in manufacturing.

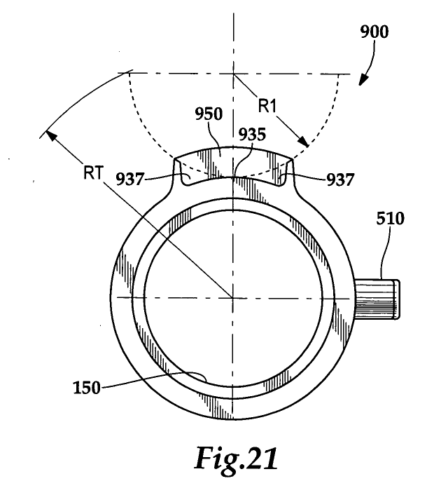

In FIGS. 11B, 13 and 17, the legs or sides 930 or 932 which form the U-shaped structures on the exterior of the coupling can be positioned to project radially out from the coupling at a tangent to the circle formed by the cross section of the coupling (see FIG. 21). By positioning the legs/sides of the U-shaped member in this manner, and positioning them in pairs (e.g. at roughly 8:30 and 9:30; 2:30 and 3:30, etc., as opposed to projecting outward from a line extending from the centerpoint of the circle, the manufacturability of the part will be enhanced. This is due to the fact that the mold cavity can be kept simpler, with less moving parts. In fact, if the pairs of ribs are positioned only at, for example, the 8:30 and 9:30 position and 2:30 and 3;30 position, then the mold cavity can be made to split at the 12:00 position and 6:00 position in two simple halves. This would keep the mold design as a simple arrangement of two split cavities with removable cores, as opposed to a mold with a lot of parts that are required to move by means of hydraulics and/or operated with robotics.

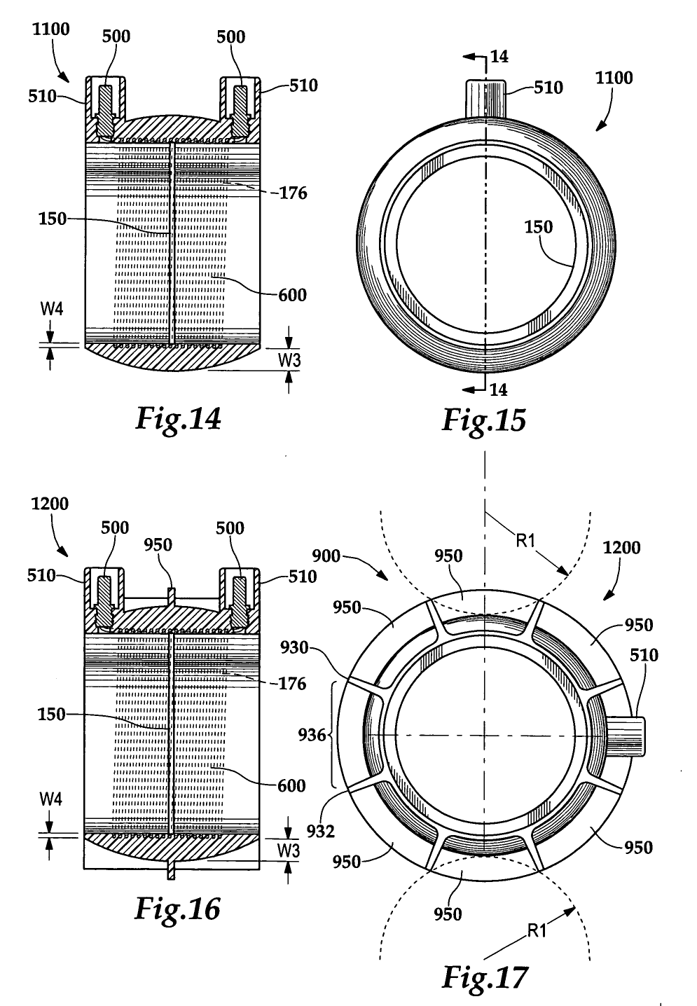

Referring now to FIGS. 14 and 15 therein is illustrated electro-fusion coupling 1100. The wall thickness of the coupling 1100 decreases with distance from the center portion of the coupling proceeding from a wall thickness of W₃ at the center to a wall thickness of W₄ at the end of the coupling, thereby also saving on material used in forming the coupling and providing a thicker wall thickness where the stress is greater during the electro-fusion operation. It will be understood in some implementations that a central portion of the coupling may have an outer surface parallel to the inner surface of the coupling as illustrated in FIG. 1. The tapered wall may begin at the terminus of such central portion and taper to a position proximate to the end of the coupling.

Referring now to FIGS. 16 and 17 therein is an electro-fusion coupling 1200 having a tapered wall as illustrated and discussed with regards to FIGS. 14 and 15 and with U-shaped projections 936 and center stops 950 as illustrated and discussed with regard to FIGS. 10A, 10B, 10C, 11A, 11B, 11C, and 13. The center stop 950 functions as a stiffening cross brace and the U-shaped projections 936 serve as stiffening vanes, thereby allowing the coupling wall thickness to be reduced and results in a savings of material used in manufacturing.

In the tapered coupling shown in FIG. 17, at the ends of some of the pairs of these axially positioned stiffening vanes, a thin radial vane can be formed at the outer edge of the coupling. The purpose of this vane is to give the pipe member a place to rest against, when using the U-shaped member and external center stop to mark the coupling. Since the exterior of the tapered coupling is not an even surface, if the exterior radial vane is made to the proper height in its center where its center height equals the largest diameter at the point where the exterior center stop is formed, then this allows the pipe to be held in a straight position. It would be further beneficial if this radial vane is formed as a curve at its outer edge which matches the outside diameter of the pipe to which it is being positioned against it. This allows for the pipe to be held snugly in position for marking, and also allows for a place along which to trace the marking instrument. The exterior of the coupling at the point where the center stop is formed could also have a slight U-shaped curve incorporated to allow the pipe to sit snugly along the inside as well as along the outer radial marking vane to allow for the pipe to be snugly held in place for marking.

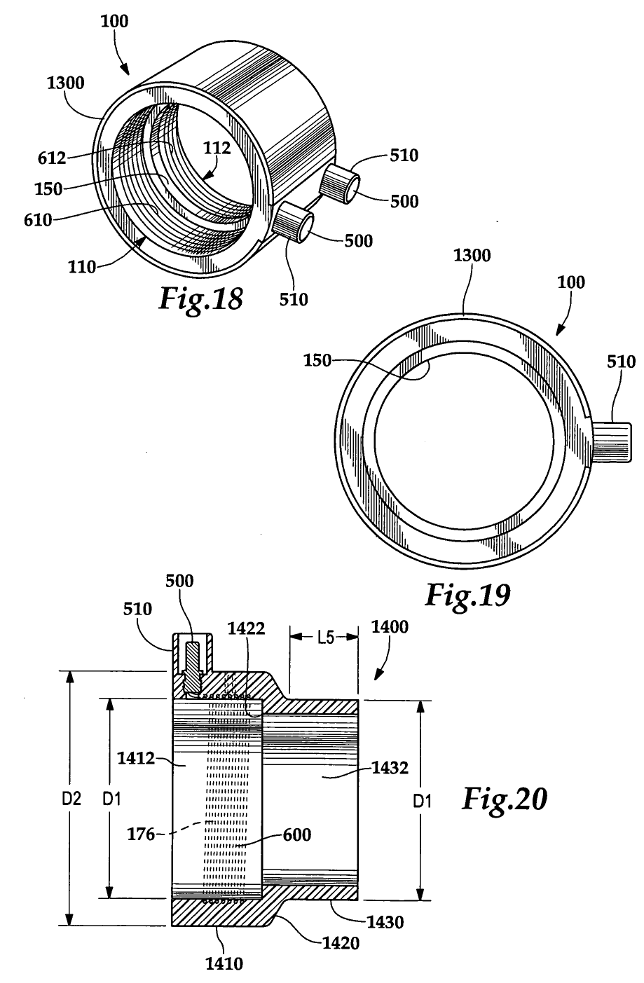

Now turning to FIGS. 18 and 19, wherein there is illustrated a coupling 100 as illustrated and described in FIGS. 1, 2, 3A, 3B, 3C and 3D with one or more stiffening rings 1300 disposed proximal to the end of the coupling. It will be understood that the ring 1300 may be a continuous circumferential ring or may be a discontinuous split ring. The ring may be used on one or both ends of the coupling to provide support and reduce the material used in the coupling.

Referring now to FIG. 20 therein is disclosed a transition coupling 1400 used to make a transition from electro-fusion coupling systems to either mechanical or socket fusion prior art socket connections. The transition coupling has a tubular body with a first bell (female) end portion 1410 and a spigot end (male) portion 1430 and a central transition portion 1420 between the two end portions. A passageway from the first end to the second end of the coupling is defined by an inner surface 1412 of the first bell end portion and an inner surface 1422 of the central transition portion and an inner surface 1432 of the second spigot end portion. A spiral groove 600 is inscribed in the inner surface of the first bell end and a resistive heating element 176 comprising a wire is disposed in the spiral groove. The heating element 176 is connected to conductive terminals 500 disposed in the first portion of the coupling. The second spigot portion 1430 (male end) has an outside surface with an outside diameter D1 substantially the same as the inside diameter D1 of the inner surface of the bell end portion. The spigot portion can be inserted into the bell (female) end of any prior art mechanical or socket fusion socket connector such as standard coupling, wye, tee or elbow to transition from an electro-fusion system to a mechanical or glued system.

A number of embodiments of the invention have been described. Nevertheless, it will be understood that various modifications may be made without departing from the spirit and scope of the invention. Accordingly, other embodiments are within the scope of the following claims.

What is claimed is:

1. An electro-fusion drainage system coupling, said coupling comprising a tubular body including:
a first end portion proximal to a first end;
a second end portion proximal to a second end;
a central portion between the two end portions;
an outer surface on the central portion and an inner surface on the central portion, the inner surface defining a passageway from the first end to the second end;
a resistive heating element disposed in the passageway;
at least one ridge integrally molded on the exterior surface of the central portion of the body, said ridge having a first edge generally perpendicular to the outer surface and positioned at a predetermined distance from the end of the body, said predetermined distance representing a desired insertion distance of a first proximal end portion of first thermoplastic pipe inserted into the passageway of said coupling body.

2. The electro-fusion coupling of claim 1 further comprising a stop surface in the passageway of the body, said stop surface positioned for contact with a first proximal end portion of first thermoplastic pipe inserted into the passageway of said coupling body.

3. The electro-fusion coupling of claim 2 wherein the stop surface comprises a polypropylene ring sized to be partially received in a radial groove milled in the inner surface of the body before the spiral groove is milled in the inner surface and said stop surface partially extending from the groove, wherein said ring is positioned in the radial groove after the heating element is positioned in the spiral groove.

4. The electro-fusion coupling of claim 1 wherein said ridge has a maximum predetermined (distal distance) radial extension from the outer surface of the body, said predetermined maximum radial extension being less than an inside diameter of a polymeric pipe of two nominal sizes larger that the first thermoplastic pipe to be inserted into the coupling.

5. The electro-fusion coupling of claim 4 wherein said ridge extends circumferentially about the exterior surface of the coupling and said ridge extends radially outward from a region of the stop on the inner surface of the coupling.

6. The electro-fusion coupling of claim 1 further comprising a fitting integrally formed on a second end of said coupling, the fitting selected from the group consisting of tee-fittings, elbow-fittings and wye-fittings.

7. The electro-fusion coupling of claim 1 wherein the outer surface of the central portion and the inner surface of the central portion are substantially parallel.

8. The electro-fusion coupling of claim 1 wherein the outer surface of the first end portion and the second end portion tapers from the central portion to the first and second ends respectively.

9. The electro-fusion coupling of claim 1 wherein the outer surface of the central portion and the first end and second end portions taper away from the integrally molded ridge on the central portion.

10. An electro-fusion drainage system coupling, said coupling comprising a tubular body selected from the group of polypropylene and PVDF, said body including:
a first end portion proximal to a first end;
a second end portion proximal to a second end;
a central portion between the two end portions;
an outer surface of the central portion and an inner surface of the central portion, the inner surface defining a passageway from the first end to the second end;
a first spiral groove in the inner surface extending from the first portion of the body toward the central portion of the body;
a second spiral groove in the inner surface extending from the central portion of the body toward the second portion of the body;
a first resistive heating element comprising a wire disposed in the first spiral groove;
a second resistive heating element comprising a wire disposed in the second spiral groove; and
at least one ridge integrally molded on the exterior surface of the central portion of the body, said ridge having a first edge generally perpendicular to the outer surface and positioned at a predetermined distance from the end of the body, said predetermined distance representing a desired insertion distance of a first proximal end portion of a first thermoplastic pipe inserted into the passageway of said coupling body.

11. The electro-fusion coupling of claim 10 further comprising a stop surface in the passageway of the body, said stop surface positioned for contact with a first proximal end portion of first thermoplastic pipe inserted into the passageway of said coupling body.

12. The electro-fusion coupling of claim 11 wherein said ridge extends circumferentially about the exterior surface of the coupling and said ridge extends radially outward from a region of the stop on the inner surface of the coupling.

13. The electro-fusion coupling of claim 10 further comprising a fitting integrally formed on one end of said coupling, the fitting selected from the group consisting of tee-fittings, elbow-fittings and wye-fittings.

14. The electro-fusion coupling of claim 10 wherein the first spiral groove and the second spiral groove are connected by an intermediate spiral groove having a different pitch in the central portion of the body.

15. The electro-fusion coupling of claim 14 wherein the first and second heating elements are a continuous wire disposed in the first spiral groove, the intermediate spiral groove and the second spiral groove.

16. The electro-fusion coupling of claim 11 wherein the outer surface of the central portion and the inner surface of the central portion are substantially parallel.

17. The electro-fusion coupling of claim 11 wherein the outer surface of the first end portion and the second end portion tapers from the central portion to the first and second ends respectively.

18. The electro-fusion coupling of claim 11 wherein the outer surface of the central portion and the first end and second end portions taper away from the integrally molded ridge on the central portion.

19. An electro-fusion drainage system coupling, said coupling comprising a tubular body including:
a first end portion proximal to a first end;
a second end portion proximal to a second end;
a central portion between the two end portions;
an outer surface and an inner surface, the inner surface defining a passageway from the first end to the second end;
a resistive heating element disposed in the passageway;
at least one U-shaped member integrally molded on the outer surface of the central portion, said U-shaped member having a first leg and a second leg adapted to contact a first proximal end portion of a first thermo-plastic pipe to be inserted into the passageway of said coupling body; and
an outer stop disposed in the bottom of the U-shaped member, said stop having a first edge generally perpendicular to the bottom of the U-shaped member and positioned at a predetermined distance from the end of the body, said predetermined distance representing a desired insertion distance of a first proximal end portion of first thermoplastic pipe to be inserted into the passageway of said coupling body.

20. The electro-fusion coupling of claim 19 further comprising an interior stop surface in the passageway of the body, said stop surface positioned for contact with a first proximal end portion of first thermoplastic pipe inserted into the passageway of said coupling body.

21. The electro-fusion coupling of claim 19 wherein the interior stop surface comprises a polypropylene ring sized to be partially received in a radial groove milled in the inner surface of the body and said stop surface partially extending from the groove.

22. The electro-fusion coupling of claim 19 wherein the bottom of the U-shaped member has an internal radius of curvature substantially equal to the external radius of curvature of the thermoplastic pipe to be inserted into the passageway of said coupling body.

23. The electro-fusion coupling of claim 19 further comprising a plurality of said U-shaped members disposed on the center portion of said coupling body.

24. The electro-fusion coupling of claim 19 wherein the outer surface of the central portion and the inner surface of the central portion are substantially parallel.

25. The electro-fusion coupling of claim 19 wherein the outer surface of the first end portion and the second end portion tapers from the central portion to the first and second ends respectively.

26. The electro-fusion coupling of claim 19 wherein the outer surface of the central portion and the first end and second end portions taper away from the U-shaped member molded on the central portion.

27. The electro-fusion coupling of claim 19 further including at least one void disposed between the bottom of the U-shaped member and the outer surface of the coupling body.

28. The electro-fusion coupling of claim 19 wherein said U-shaped member has a maximum predetermined (distal distance) radial extension from the outer surface of the body, said predetermined maximum radial extension being less than an inside diameter of a polymeric pipe of two nominal sizes larger that the first thermoplastic pipe to be inserted into the coupling.

29. The electro-fusion coupling of claim 19 further comprising a fitting integrally formed on a second end of said coupling, the fitting selected from the group consisting of tee-fittings, elbow-fittings and wye-fittings.

30. The electro-fusion drainage system coupling, said coupling comprising a tubular body formed of a first polymeric material including:
a first end portion proximal to a first end;
a second end portion proximal to a second end;
a central portion between the two end portions;
an outer surface of the coupling and an inner surface of the coupling, the inner surface defining a passageway from the first end to the second end;
a resistive heating element disposed in the passageway;
at least one stiffening ring of a second material, said material having greater tensile strength than the first material of the tubular body, said stiffening ring disposed permanently on the outer surface of said coupling.

31. A method of manufacturing an electro-fusion coupling comprising the steps of:
providing a preformed female socket coupling having at least one end with a female socket coupling, said female socket end having an interior surface;
inscribing a spiral groove on said interior surface;
disposing a resistive heating element in said groove;
connecting said resistive heating element to conductive terminals.

32. The method of claim 31 further including the step of milling the interior surface of the preformed female socket coupling end to a predetermined profile before inscribing the spiral groove in the interior surface.

33. A method of joining polymeric drainage pipe using electro-fusion, said method comprising the steps of:
providing a first piece and a second piece of polymeric tubular pipe to be joined, each with a proximal terminal end and a proximal end portion adjacent to the proximal terminal end;
providing an electro-fusion coupling, said coupling comprising a generally tubular body, said body including:
a first end portion proximal to the first end,
a second end portion proximal to the second end,
a central portion between the two end portions,
an outer surface of the central portion and an inner surface of the central portion, and the inner surface defining a passageway from the first end to the second end,
a resistive heating element disposed in the passageway of the coupling;
positioning a squared-off, terminal proximal end of the pipe to be joined adjacent to and in contact with an integral ridge disposed on the exterior parallel surface of the central portion of the electro-fusion coupling, wherein said tubular pipe is further positioned such that a longitudinal axis of the pipe and a longitudinal axis of the coupling are generally parallel to each other and an outside surface of tubular pipe is adjacent to and in contact with the outside parallel surface of the electro-fusion coupling; marking the outside surface of the pipe at the end of the coupling, wherein the distance from the mark on the outside surface of the pipe to the first proximal terminal end of the pipe is representative of the predetermined distance of insertion of the first proximal terminal end of the pipe into the first end portion of the electro-fusion coupling;
inserting the proximal terminal end of the first piece of pipe to be joined in a first end portion of the electro-fusion coupling a predetermined distance of insertion;
inserting the proximal terminal end of the second piece of pipe to be joined in a second end portion of the electro-fusion coupling a predetermined distance; and
applying an electrical current to the resistive element and heating the resistive heating element to a temperature sufficient to fuse each end of the tubular pipe to the coupling without external support of the outside of the tubular body of the electro-fusion coupling.

34. The method of claim 33 further comprising the step of inserting the terminal proximal end of the pipe into the electro-fusion coupling until the terminal end contacts a stop disposed in the passageway of the central portion of the coupling.

35. A method of joining polymeric drainage pipe using electro-fusion, said method comprising the steps of:
providing a first piece and a second piece of polymeric tubular pipe to be joined, each with a proximal terminal end and a proximal end portion adjacent to the proximal terminal end;
providing an electro-fusion coupling, said coupling comprising a generally tubular body, said body including:
a first end portion proximal to the first end,
a second end portion proximal to the second end,
a central portion between the two end portions,
an outer surface and an inner surface, the inner surface defining a passageway from the first end to the second end,
a resistive heating element disposed in the passageway of the coupling;
positioning a squared-off, terminal proximal end of the pipe to be joined adjacent to and in contact with an external stop disposed in a U-shaped member on the central portion of the electro-fusion coupling;
marking the outside surface of the pipe at the end of the coupling, wherein the distance from the mark on the outside surface of the pipe to the first proximal terminal end of the pipe is representative of the predetermined distance of insertion of the first proximal terminal end of the pipe into the first end portion of the electro-fusion coupling;
inserting the proximal terminal end of the first piece of pipe to be joined in a first end portion of the electro-fusion coupling a predetermined distance of insertion;
inserting the proximal terminal end of the second piece of pipe to be joined in a second end portion of the electro-fusion coupling a predetermined distance; and
applying an electrical current to the resistive element and heating the resistive heating element to a temperature sufficient to fuse each end of the tubular pipe to the coupling without external support of the outside of the tubular body of the electro-fusion coupling.

36. The method of claim 35 further comprising the step of inserting the terminal proximal end of the pipe into the electro-fusion coupling until the terminal end contacts a stop disposed in the passageway of the central portion of the coupling.

37. An electro-fusion drainage system coupling, said coupling comprising a tubular body including:
a first end portion proximal to a first end;
a second end portion proximal to a second end;
a central portion between the two end portions;
an outer surface on the central portion and an inner surface on the central portion, the outer surface and the inner surface being substantially parallel, the inner surface defining a passageway from the first end to the second end;
a resistive heating element disposed in the passageway;
at least one U-shaped member integrally molded on the outer surface of the central portion, said U-shaped member having a first leg and a second leg adapted to contact a first proximal end portion of a first thermo-plastic pipe to be inserted into the passageway of said coupling body; and
an outer stop disposed in the bottom of the U-shaped member, said stop having a first edge generally perpendicular to the bottom of the U-shaped member;
said U-shaped member having an edge generally perpendicular to the outer surface of the body and positioned at a predetermined distance from the first edge of the end of the outer stop, said predetermined distance representing a desired insertion distance of a first proximal end portion of first thermoplastic pipe inserted into the passageway of said coupling body.

38. An electro-fusion drainage system transition coupling, said transition coupling comprising a tubular body, said body including:
a first bell end portion proximal to a first end;
a second spigot portion proximal to a second end;
a central transition portion between the two end portions;
a passageway from the first end to the second end of the coupling defined by an inner surface of the first bell end portion and an inner surface of the central transition portion and an inner surface of the second spigot end portion;
a spiral groove in the inner surface of the first bell end;
a resistive heating element comprising a wire disposed in said spiral groove;
conductive terminals disposed in the first portion of the coupling and connected to the heating element; and
an outside surface of said spigot portion having an outside diameter substantially the same as an inside diameter of the inner surface of the bell end portion.
